(19) United States
(12) Patent Application Publication
(10) Pub. No.: US 2017/0361545 A1
(43) Pub. Date: Dec. 21, 2017

(54) FIBER-REINFORCEMENT OF FOAM MATERIALS, CONSISTING OF INTERCONNECTED SEGMENTS

(71) Applicant: BASF SE, Ludwigshafen (DE)

(72) Inventors: Holger RUCKDÄSCHEL, St. Martin (DE); Rene ARBTER, Freinsheim (DE); Robert STEIN, Altrip (DE); Daniela LONGO-SCHEDEL, Sankt Augustin (DE); Tim DIEHLAMAN, Obrigheim-Colgenstein (DE); Bangaru SAMPATH, Ludwigshafen (DE); Peter GUTMANN, Karlsruhe (DE); Alexandre TERRENOIRE, Ludwigshafen (DE); Markus HARTENSTEIN, Rülzheim (DE); Andreas KIRGIS, Mannheim (DE); Alessio MORINO, Castagneto Po (IT); Gregor DAUN, Neckargemünd (DE); Marc Claude MARTIN, Lemförde (DE)

(21) Appl. No.: 15/538,496

(22) PCT Filed: Dec. 15, 2015
(86) PCT No.: PCT/EP2015/079805

§ 371 Date: Jun. 21, 2017

(30) Foreign Application Priority Data
Dec. 22, 2014 (EP) 14199629.8

(51) Int. Cl. B29C 70/08; B32B 5/24; B32B 5/18; B29C 70/24; B32B 7/04; B29C 44/34; B29L 31/08

(52) U.S. Cl. CPC B29C 70/086; B32B 7/04; B32B 5/245; B29C 44/352; B32B 5/18; B29C 70/24; B29L 2031/085

(57) ABSTRACT

The present invention relates to a molding made from foam, wherein at least one fiber (F) is partly within the molding, i.e. is surrounded by the foam. The two ends of the respective fibers (F) that are not surrounded by the foam thus each project from one side of the corresponding molding. The foam comprises at least two mutually bonded foam segments.

The present invention relates to a molding made from foam, wherein at least one fiber (F) is partly within the molding, i.e. is surrounded by the foam. The two ends of the respective fibers (F) that are not surrounded by the foam thus each project from one side of the corresponding molding. The foam comprises at least two mutually bonded foam segments.

The present invention further provides a panel comprising at least one such molding and at least one further layer (S1). The present invention further provides processes for producing the moldings of the invention from foam or the panels of the invention and the use thereof, for example as rotor blade in wind turbines.

WO 2006/125561 relates to a process for producing a reinforced cellular material, wherein at least one hole extending from a first surface to a second surface of the cellular material is produced in the cellular material in a first process step. On the other side of the second surface of the cellular material, at least one fiber bundle is provided, said fiber bundle being drawn with a needle through the hole to the first side of the cellular material. However, before the needle takes hold of the fiber bundle, the needle is first pulled through the particular hole coming from the first side of the cellular material. In addition, the fiber bundle on conclusion of the process according to WO 2006/125561 is partly within the cellular material, since it fills the corresponding hole, and the corresponding fiber bundle partly projects from the first and second surfaces of the cellular material on the respective sides.

By the process described in WO 2006/125561, it is possible to produce sandwich-like components comprising a core of said cellular material and at least one fiber bundle. Resin layers and fiber-reinforced resin layers may be applied to the surfaces of this core, in order to produce the actual sandwich-like component. Cellular materials used to form the core of the sandwich-like component may, for example, be polyvinyl chlorides or polyurethanes. Examples of useful fiber bundles include carbon fibers, nylon fibers, glass fibers or polyester fibers.

However, WO 2006/125561 does not disclose that foams comprising at least two mutually bonded foam segments can also be used as cellular material for production of a core in a sandwich-like component. The sandwich-like components according to WO 2006/125561 are suitable for use in aircraft construction.

WO 2011/012587 relates to a further process for producing a core with integrated bridging fibers for panels made from composite materials. The core is produced by pulling the bridging fibers provided on a surface of what is called a “cake” made from lightweight material partly or completely through said cake with the aid of a needle. The “cake” may be formed from polyurethane foams, polyester foams, polyethylene terephthalate foams, polyvinyl chloride foams or a phenolic foam, especially from a polyurethane foam. The fibers used may in principle be any kind of single or multiple threads and other yarns.

The cores thus produced may in turn be part of a panel made from composite materials, wherein the core is surrounded on one or two sides by a resin matrix and combinations of resin matrices with fibers in a sandwich-like configuration. However, WO 2011/012587 does not disclose that foams comprising at least two mutually bonded foam segments can be used for production of the corresponding core material.

WO 2012/138445 relates to a process for producing a composite core panel using a multitude of longitudinal strips of a cellular material having a low density. A twin-layer fiber mat is introduced between the individual strips, and this brings about bonding of the individual strips, with use of resin, to form the composite core panels. The cellular material having a low density that forms the longitudinal strips, according to WO 2012/138445, is selected from balsa wood, elastic foams and fiber-reinforced composite foams. The fiber mats introduced in twin-layer form between the individual strips may, for example, be a porous glass fiber mat. The resin used as adhesive may, for example, be a polyester, an epoxy resin or a phenolic resin, or a heat-activated thermoplastic, for example polypropylene or PET. However, WO 2012/138445 does not disclose that individual fibers or fiber bundles can be incorporated into the cellular material for reinforcement. According to WO 2012/138445, exclusively fiber mats that additionally constitute a bonding element in the context of adhesive bonding of the individual strips by means of resin to obtain the core material are used for this purpose.

GB-A 2 455 044 discloses a process for producing a multilayer composite article, wherein, in a first process step, a multitude of beads of thermoplastic material and a blowing agent are provided. The thermoplastic material is a mixture of polystyrene (PS) and polyphenylene oxide (PPO) comprising at least 20% to 70% by weight of PPO. In a second process step the beads are expanded, and in a third step they are welded in a mold to form a closed-cell foam of the thermoplastic material to give a molding, the closed-cell foam assuming the shape of the mold. In the next process step, a layer of fiber-reinforced material is applied to the surface of the closed-cell foam, the attachment of the respective surfaces being conducted using an epoxy resin. However, GB-A 2 455 044 does not disclose that a fiber material can be introduced into the core of the multilayer composite article.

An analogous process and an analogous multilayer composite article (to those in GB-A 2 455 044) is also disclosed in WO 2009/047483. These multilayer composite articles are suitable, for example, for use as rotor blades (in wind turbines) or as ships' hulls.

U.S. Pat. No. 7,201,625 discloses a process for producing foam products and the foam products as such, which can be used, for example, in the sports sector as a surfboard. The core of the foam product is formed by a molded foam, for example based on a polystyrene foam. This molded foam is produced in a special mold, with an outer plastic skin surrounding the molded foam. The outer plastic skin may, for example, be a polyethylene film. However, U.S. Pat. No. 7,201,625 also does not disclose that fibers for reinforcement of the material may be present in the molded foam.

U.S. Pat. No. 6,767,623 discloses sandwich panels having a core layer of molded polypropylene foam based on particles having a particle size in the range from 2 to 8 mm and a bulk density in the range from 10 to 100 g/L. In addition, the sandwich panels comprise two outer layers of fiber-reinforced polypropylene, with the individual outer layers being arranged around the core so as to form a sandwich. Still further layers may optionally be present in the sandwich panels for decorative purposes. The outer layers may comprise glass fibers or other polymer fibers.

EP-A 2 420 531 discloses extruded foams based on a polymer such as polystyrene in which at least one mineral filler having a particle size of ≦10 μm and at least one nucleating agent are present. These extruded foams are notable for their improved stiffness. Additionally described is a corresponding extrusion process for producing such extruded foams based on polystyrene. The extruded foams may have closed cells. However, EP-A 2 480 531 does not state that the extruded foams comprise fibers or comprise at least two mutually bonded foam segments.

WO 2005/056653 relates to molded foams formed from expandable polymer beads comprising filler. The molded foams are obtainable by welding prefoamed foam beads formed from expandable thermoplastic polymer beads comprising filler, the molded foam having a density in the range from 8 to 300 g/L. The thermoplastic polymer beads especially comprise a styrene polymer. The fillers used may be pulverulent inorganic substances, metal, chalk, aluminum hydroxide, calcium carbonate or alumina, or inorganic substances in the form of beads or fibers, such as glass beads, glass fibers or carbon fibers.

US 2001/0031350 describes sandwich materials comprising a fiber-reinforced, closed-cell material with a low density, reinforcing fiber layers and a resin. The closed-cell material having a low density is a foam. The core material of the sandwich materials comprises segments of the foam that are bonded to one another by fiber layers. In addition, fibers, for example in the form of rovings, may be introduced into the segments for reinforcement, and may penetrate the fiber layers. The fiber is present with a region within the core material, and a second fiber region projects from the first side of the foam and a third fiber region from the second side. In order to introduce the fiber into the foam, US 2001/0031350 uses needles. The needles produce a hole from the first side of the foam to the second side, while simultaneously bringing the fiber from the first side of the foam to the second side of the foam, such that the fiber is partly within the foam and partly outside the foam.

The object underlying the present invention is that of providing novel fiber-reinforced moldings or panels.

This object is achieved in accordance with the invention by a molding made of foam, said foam comprising at least two mutually bonded foam segments, in which at least one fiber (F) is present with a fiber region (FB2) within the molding and is surrounded by the foam, while a fiber region (FB1) of the fiber (F) projects from a first side of the molding and a fiber region (FB3) of the fiber (F) projects from a second side of the molding, where the fiber (F) has been partly introduced into the foam by a process comprising the following steps a) to f):
a) optionally applying at least one layer (S2) to at least one side of the foam,
b) producing one hole per fiber (F) in the foam and in any layer (S2), the hole extending from a first side to a second side of the foam and through any layer (S2),
c) providing at least one fiber (F) on the second side of the foam,
d) passing a needle from the first side of the foam through the hole to the second side of the foam, and passing the needle through any layer (S2),
e) securing at least one fiber (F) on the needle on the second side of the foam, and
f) returning the needle along with the fiber (F) through the hole, such that the fiber (F) is present with the fiber region (FB2) within the molding and is surrounded by the foam, while the fiber region (FB1) of the fiber (F) projects from a first side of the molding or from any layer (S2) and the fiber region (FB3) of the fiber (F) projects from a second side of the molding.

The present invention further provides a molding made of foam, said foam comprising at least two mutually bonded foam segments, in which at least one fiber (F) is present with a fiber region (FB2) within the molding and is surrounded by the foam, while a fiber region (FB1) of the fiber (F) projects from a first side of the molding and a fiber region (FB3) of the fiber (F) projects from a second side of the molding.

The details and preferences which follow apply to both embodiments of the inventive molding made from foam.

The moldings of the invention feature improved mechanical properties. In the regions in which the at least two foam segments have been bonded to one another, the at least one fiber (F) additionally has better fixing. The regions in which the at least two foam segments are bonded to one another thus act as support sites for the fiber (F). This is especially the case in a preferred embodiment of the present invention when the foam segments are bonded to one another by adhesive bonding and/or welding. Since the at least one fiber (F) has better fixing in the foam, there is an increase in its pullout resistance. This also improves the reprocessing of the moldings, for example in the production of the panel of the invention. Moreover, fiber orientation in the foam can be better controlled.

A further advantage is considered to be that the regions in which at least two foam segments are bonded to one another reduce any possible crack growth in the moldings, since they prevent propagation of the cracks. This increases the lifetime and the damage tolerance of the moldings of the invention.

The moldings of the invention also advantageously feature low resin absorption with simultaneously good interfacial binding. This effect is important especially when the moldings of the invention are being processed further to give the panels of the invention.

The use of a foam comprising at least two mutually bonded foam segments for production of the moldings of the invention allows better control over the foam structure compared to slabs of equal size made from one foam segment. In the case of mutually bonded foam segments, it is possible to achieve, for example, smaller, more homogeneous cell sizes, more anisotropic properties and narrower geometric tolerances.

Since, in a preferred embodiment of the molding, the foam segments comprise cells and these are anisotropic to an extent of at least 50%, preferably to an extent of at least 80% and more preferably to an extent of at least 90%, in one embodiment, the mechanical properties of the foam and hence also those of the molding are also anisotropic, which is particularly advantageous for use of the molding of the invention, especially for rotor blades, in wind turbines, in the transport sector, in the construction sector, in automobile construction, in shipbuilding, in rail vehicle construction, in container construction, in sanitary facilities and/or in aerospace.

The bonding of the foam segments allows the anisotropic foam segments to be aligned in a controlled manner, in order to achieve, for example, orientations of the mechanical properties that have load-bearing capability or minimum resin absorptions.

The moldings of the invention have particularly high compressive strength in at least one direction because of their anisotropy. They additionally feature a high closed cell content and good vacuum stability.

A further improvement in binding with simultaneously reduced resin absorption is enabled in accordance with the invention by the fiber reinforcement of the foams in the moldings of the invention or the panels that result therefrom. According to the invention, the fibers (individually or preferably in the form of fiber bundles) can advantageously be introduced into the foam at first in dry form and/or by mechanical processes. The fibers or fiber bundles are not laid down flush with the respective foam surfaces, but with an excess, and hence enable improved binding or direct connection to the corresponding outer plies in the panel of the invention. This is the case especially when the outer ply applied to the moldings of the invention, in accordance with the invention, is at least one further layer (S1) to form a panel. Preference is given to applying two layers (S1), which may be the same or different. More preferably, two identical layers (S1), especially two identical fiber-reinforced resin layers, are applied to opposite sides of the molding of the invention to form a panel of the invention. Such panels are also referred to as “sandwich materials”, in which case the molding of the invention can also be referred to as “core material”.

The panels of the invention are thus notable for low resin absorption in conjunction with good peel strength. Given appropriate orientation of anisotropic foam segments, it is additionally possible to achieve high crease resistances. Moreover, high strength and stiffness properties can be established in a controlled manner via the choice of fiber types and the proportion and arrangement thereof. The effect of low resin absorption is important because a common aim in the case of use of such panels (sandwich materials) is that the structural properties should be increased with minimum weight. In the case of use of fiber-reinforced outer plies, for example, as well as the actual outer plies and the sandwich core, the resin absorption of the core material makes a contribution to the total weight. However, the moldings of the invention or the panels of the invention can reduce the resin absorption, which can save weight and costs.

A further advantage of the moldings or panels of the invention is considered to be that the use of foams and the associated production makes it relatively simple to incorporate integrated structures such as slots or holes on the surfaces of the moldings and to process the moldings further. In the case of use of such moldings (core materials), structures of this kind are frequently introduced, for example, into curved structures (deep slots) for draping, for improvement of processibility by liquid resin processes such as vacuum infusion (holes), and for acceleration of the processing operation mentioned (shallow slots).

Through the use of foam segments, it is additionally possible to integrate structures of this kind at an early stage, prior to bonding. It is thus possible to achieve geometric structures in the moldings that are otherwise realizable by technical means only with an elevated level of complexity, if at all. For example, it is possible for holes to be integrated in the molding within the foam and parallel to the foam surface.

Further improvements/advantages can be achieved in that the fibers are introduced into the foam at an angle α in the range from 0° to 60° in relation to the thickness direction (d) of the foam, more preferably from 0° to 45°. Generally, the introduction of the fibers at an angle α of 0° to <90° is performable industrially.

Additional improvements/advantages can be achieved when the fibers are introduced into the foam not only in a parallel manner, but further fibers are also introduced at an angle β to one another which is preferably in the range from >0 to 180°. This additionally achieves an improvement in the mechanical properties of the molding of the invention.

It is likewise advantageous when the (outer) resin layer in the panels of the invention is applied by liquid injection methods or liquid infusion methods, in which the fibers can be impregnated with resin during processing and the mechanical properties improved. In addition, cost savings are thereby possible.

The present invention is specified further hereinafter.

According to the invention, the molding comprises a foam and at least one fiber (F).

The foam comprises at least two mutually bonded foam segments. This means that the foam may comprise two, three, four or more mutually bonded foam segments.

The foam segments may be based on any polymers known to those skilled in the art.

For example, the foam segments of the foam are based on at least one polymer selected from polystyrene, polyester, polyphenylene oxide, a copolymer prepared from phenylene oxide, a copolymer prepared from styrene, polyaryl ether sulfone, polyphenylene sulfide, polyaryl ether ketone, polypropylene, polyethylene, polyamide, polyamide imide, polyether imide, polycarbonate, polyacrylate, polylactic acid, polyvinyl chloride, or a mixture thereof, the polymer preferably being selected from polystyrene, polyphenylene oxide, a mixture of polystyrene and polyphenylene oxide, polyethylene terephthalate, polycarbonate, polyether sulfone, polysulfone, polyether imide, a copolymer prepared from styrene, or a mixture of copolymers prepared from styrene, the polymer more preferably being polystyrene, a mixture of polystyrene and poly(2,6-dimethylphenylene oxide), a mixture of a styrene-maleic anhydride polymer and a styrene-acrylonitrile polymer, or a styrene-maleic anhydride polymer (SMA).

Also suitable as foams are thermoplastic elastomers. Thermoplastic elastomers are known as such to those skilled in the art.

Polyphenylene oxide is preferably poly(2,6-dimethylphenylene ether), which is also referred to as poly(2,6-dimethylphenylene oxide).

Suitable copolymers prepared from phenylene oxide are known to those skilled in the art. Suitable copolymers for phenylene oxide are likewise known to those skilled in the art.

A copolymer prepared from styrene preferably has, as comonomer for styrene, a monomer selected from α-methylstyrene, ring-halogenated styrenes, ring-alkylated styrenes, acrylonitrile, acrylic esters, methacrylic esters, N-vinyl compounds, maleic anhydride, butadiene, divinylbenzene and butanediol diacrylate.

Preferably, all foam segments of the foam are based on the same polymers. This means that all foam segments of the foam comprise the same polymers, and preferably all foam segments of the foam consist of the same polymers.

The foam segments of the foam have been made, for example, from a molded foam, an extruded foam, a reactive foam and/or a masterbatch foam, preferably from an extruded foam, especially an extruded foam that has been produced in a process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam,
IV) calibrating the expanded foam from step III) by conducting the expanded foam through a shaping tool to obtain the extruded foam,
V) optional material-removing processing of the extruded foam obtained in step IV),
   where
i) the polymer melt provided in step I) optionally comprises at least one additive, and/or
ii) at least one additive is optionally added during step II) to the polymer melt and/or between step II) and step III) to the foamable polymer melt, and/or
iii) at least one additive is optionally applied during step III) to the expanded foam and/or during step IV) to the expanded foam, and/or
iv) at least one layer (S2) is optionally applied to the extruded foam during and/or directly after step IV).

Suitable methods for provision of the polymer melt in the extruder in step I) are in principle all methods known to those skilled in the art; for example, the polymer melt can be provided in the extruder by melting an already ready-polymerized polymer. The polymer can be melted directly in the extruder; it is likewise possible to feed the polymer to the extruder in molten form and thus to provide the polymer melt in the extruder in step I). It is likewise possible that the polymer melt is provided in step I) in that the corresponding monomers required for preparation of the polymer of the polymer melt react with one another to form the polymer in the extruder and hence the polymer melt is provided.

A polymer melt is understood in the present context to mean that the polymer is above the melting temperature (T_{M}) in the case of semicrystalline polymers or the glass transition temperature (T_{G}) in the case of amorphous polymers.

Typically, the temperature of the polymer melt in process step I) is in the range from 100 to 450° C., preferably in the range from 150 to 350° C. and especially preferably in the range from 160 to 300° C.

In step II), at least one blowing agent is introduced into the polymer melt provided in step I). Methods for this purpose are known as such to those skilled in the art.

Suitable blowing agents are selected, for example, from the group consisting of carbon dioxide, alkanes such as propane, isobutene and pentane, alcohols such as methanol, ethanol, 1-propanol, 2-propanol, 1-butanol, 2-butanol, 2-methylpropanol and tert-butanol, ethers such as dimethyl ether, ketones such as acetone and methyl ethyl ketone, halogenated hydrocarbons such as hydrofluoropropene, water, nitrogen and mixtures of these.

In step II), the foamable polymer melt is thus obtained. The foamable polymer melt comprises typically in the range from 1% to 15% by weight of the at least one blowing agent, preferably in the range from 2% to 10% by weight and especially preferably in the range from 3% to 8% by weight, based in each case on the total weight of the foamable polymer melt.

The pressure in the extruder in step II) is typically in the range from 20 to 500 bar, preferably in the range from 50 to 400 bar and especially preferably in the range from 60 to 300 bar.

In step III), the foamable polymer melt obtained in step II) is extruded through at least one die aperture from the extruder into an area at lower pressure, with expansion of the foamable polymer melt to obtain the expanded foam.

Methods of extrusion of the foamable polymer melt are known as such to those skilled in the art.

Suitable die apertures for the extrusion of the foamable polymer melt are all those known to the person skilled in the art. The die aperture may have any desired shape; for example, it may be rectangular, circular, elliptical, square or hexagonal. Preference is given to rectangular slot dies and circular round dies.

In one embodiment, the foamable polymer melt is extruded through exactly one die aperture, preferably through a slot die. In a further embodiment, the foamable polymer melt is extruded through a multitude of die apertures, preferably circular or hexagonal die apertures, to obtain a multitude of strands, the multitude of strands being combined immediately after emergence from the die apertures to form the expanded foam. The multitude of strands can also be combined only in step IV) through the passing through the shaping mold.

Preferably, the at least one die aperture is heated. Especially preferably, the die aperture is heated at least to the glass transition temperature (T_{G}) of the polymer present in the polymer melt provided in step I) when the polymer is an amorphous polymer, and at least to the melting temperature (T_{M}) of the polymer present in the polymer melt provided in step I) when the polymer is a semicrystalline polymer; for example, the temperature of the die aperture is in the range from 80 to 400° C., preferably in the range from 100 to 350° C. and especially preferably in the range from 110 to 300° C.

The foamable polymer melt is extruded in step III) into an area at lower pressure. The pressure in the area at lower pressure is typically in the range from 0.05 to 5 bar, preferably in the range from 0.5 to 1.5 bar.

The pressure at which the foamable polymer melt is extruded out of the die aperture in step III) is typically in the range from 20 to 600 bar, preferably in the range from 40 to 300 bar and especially preferably in the range from 50 to 250 bar.

In step IV), the expanded foam from step III) is calibrated by conducting the expanded foam through a shaping tool to obtain the extruded foam.

The calibration of the expanded foam determines the outer shape of the extruded foam obtained in step IV). Methods of calibration are known as such to those skilled in the art.

The shaping tool may be disposed directly at the die aperture. It is likewise possible that the shaping tool is disposed at a distance from the die aperture.

Shaping tools for calibration of the expanded foam are known as such to those skilled in the art. Suitable shaping tools include, for example, sheet calibrators, roller takeoffs, mandrel calibrators, chain takeoffs and belt takeoffs. In order to reduce the coefficient of friction between the shaping tools and the extruded foam, the tools can be coated and/or heated.

The calibration in step IV) thus fixes the geometric shape of the cross section of the extruded foam of the invention in at least one dimension. Preferably, the extruded foam has a virtually orthogonal cross section. If the calibration is partly undertaken only in particular directions, the extruded foam may depart from the ideal geometry at the free surfaces. The thickness of the extruded foam is determined firstly by the die aperture, and secondly also by the shaping tool; the same applies to the width of the extruded foam.

Suitable methods for material-removing processing, in step V), of the extruded foam obtained in step IV) are in principle all methods known to those skilled in the art. For example, the extruded foam can be subjected to material-removing processing by sawing, milling, drilling or planing. When the extruded foam is a thermoplastic foam, thermoforming is additionally possible, by means of which it is possible to avoid material-removing processing with cutting losses and damage to the fibers (F).

It will be apparent to those skilled in the art that the extruded foam obtained can be used as foam segment in the molding of the invention. The extruded foam can also first be cut or sawn into smaller segments, for example, and these smaller segments can then be used as foam segments in the molding of the invention. In addition, geometries such as slots, holes and recesses can be introduced into the extruded foam prior to joining, these having a positive effect on the properties of the molding or on the production or the properties of the panel. Alternatively, the foam can of course also be used directly after extrusion.

Based on an orthogonal system of coordinates, the length of the foam is referred to as the x direction, the width as the y direction and the thickness as the z direction. The x direction corresponds to the extrusion direction of the extruded foam when it is produced by means of extrusion.

Suitable additives are in principle all additives known to those skilled in the art, for example nucleating agents, flame retardants, dyes, process stabilizers, processing aids, light stabilizers and pigments.

With regard to the layer (S2), which in one embodiment is applied to the extruded foam, the details and preferences described further down are applicable.

According to the invention, the at least two foam segments of the foam are bonded to one another. The at least two foam segments can be bonded by any methods known to those skilled in the art. The bonding of at least two foam segments is also referred to among specialists as joining.

At least one of the following options preferably applies to the molding of the invention:
i) at least two of the mutually bonded foam segments have been bonded to one another by adhesive bonding and/or welding, and preferably all the mutually bonded foam segments of the foam of the molding have been bonded to one another by thermal welding and/or adhesive bonding, and/or
ii) the individual foam segments have a length (x direction) of at least 2 mm, preferably in the range from 20 to 8000 mm, more preferably in the range from 100 to 400 mm, a width (y direction) of at least 2 mm, preferably in the range from 5 to 4000 mm, more preferably in the range from 25 to 2500 mm, and a thickness (z direction) of at least 2 mm, preferably of at least 5 mm, more preferably of at least 25 mm, most preferably in the range from 30 to 80 mm, and/or
iii) the individual foam segments have a slab shape, and/or
iv) the individual foam segments have a ratio of length (x direction) to thickness (z direction) of at least 5, preferably of at least 10, more preferably of at least 20, most preferably in the range from 20 to 500, and/or
v) the individual foam segments have a ratio of width (y direction) to thickness (z direction) of at least 3, preferably of at least 5, more preferably of at least 10, most preferably in the range from 10 to 250, and/or
vi) at least one fiber (F) passes through at least one bonding surface between two mutually bonded foam segments of the foam, and preferably at least 20% of all fibers (F) pass through at least one bonding surface between two mutually bonded foam segments of the foam, more preferably at least 50% of all fibers (F), and/or
vii) the at least one fiber (F) passes partly or completely through at least one bonding surface between two mutually bonded foam segments at an angle β of ≧20°, preferably of 35°, especially of between 40° and 90°, and/or
viii) at least one bonding surface, preferably all bonding surfaces, between at least two of the mutually bonded foam segments has/have a thickness of at least 2 μm, preferably of at least 5 μm, more preferably in the range from 20 to 2000 μm, most preferably in the range from 50 to 800 μm, and/or
ix) the thickness of at least one bonding surface, preferably of all bonding surfaces, between at least two of the mutually bonded foam segments is greater than the sum total of the mean cell wall thicknesses of the mutually bonded foam segments, preferably 2 to 1000 times greater and more preferably 5 to 500 times greater than the sum total of the cell wall thicknesses.

The thickness of the bonding surface is understood to mean the thickness of the region between the foam segments in which the porosity of the foam segments is <10%. The porosity is understood to mean the ratio (dimensionless) of cavity volume (pore volume) to the total volume of the foam. The determination is effected, for example, by image analysis of microscope images. The cavity volume thus determined is then divided by the total volume of the foam.

The at least two mutually bonded foam segments can be bonded to one another so as to obtain a multilaminar foam. “Multilaminar” in the present context is understood to mean an at least dilaminar foam. The foam may likewise, for example, be tri-, tetra- or pentalaminar. It will be apparent to the person skilled in the art that a dilaminar foam is obtained by the combining of two foam segments, a trilaminar foam by the combining of three foam segments, and so forth. It will be appreciated that the at least dilaminar foam will have a greater thickness than the individual foam segments.

Such a multilaminar foam is preferably obtained by bonding of at least two foam segments in slab form.

The multilaminar foam can also be cut into smaller units, for example, which can in turn be bonded to one another.

For example, a multilaminar foam can be cut at right angles to the slabs and the smaller portions thus obtained can be bonded to one another.

The at least two mutually bonded foam segments may be bonded to one another by any methods known to those skilled in the art, and the at least two mutually bonded foam segments are preferably bonded to one another by adhesive bonding and/or welding.

Adhesive bonding and welding are known as such to those skilled in the art.

Adhesive bonding involves bonding the at least two foam segments bonded to one another by means of suitable adhesives (adhesion promoters).

Suitable adhesives are known to those skilled in the art. For example, it is possible to use one- or two-component adhesives, hotmelt adhesives or dispersion adhesives. Suitable adhesives are based, for example, on polychlorobutadiene, polyacrylates, styrene-acrylate copolymers, polyurethanes, epoxides or melamine-formaldehyde condensation products. The adhesive may be applied to the foam segments, for example, by spraying, painting, rolling, dipping or wetting. A general overview of adhesive bonding is given in “Habenicht, Kleben—Grundlagen, Technologien, Anwendung [Adhesive Bonding—Basics, Technology, Application]”, Springer (2008).

Methods of welding are likewise known to those skilled in the art.

The mutually bonded foam segments can be bonded to one another, for example, by thermal welding, heat staking, heating element welding, high-frequency welding, circular welding, rotary friction welding, ultrasound welding, vibration welding, hot gas welding or solvent welding.

The foam segments to be mutually bonded may be directly welded to one another, or it is additionally possible to use further layers, especially low-melting polymer films. These enable a lower welding temperature, lower compression and hence low compaction of the foam segments. Layers used may also be further materials, for example fibrous materials in the form of webs, weaves or scrims made from organic, inorganic, metallic or ceramic fibers, preferably polymeric fibers, basalt fibers, glass fibers, carbon fibers or natural fibers, more preferably glass fibers or carbon fibers.

Methods for this purpose are known to those skilled in the art and are described, for example, in EP 1213119, in DE 4421016, in US 2011/082227, in EP1318164 and in EP 2578381.

If the foam segments are bonded to one another by welding, preference is given to bonding by thermal welding.

The procedure for thermal welding as such is known to those skilled in the art. This involves exposing the respective surfaces to a heat source. Corresponding heat sources or apparatuses are known to those skilled in the art. Preference is given to conducting the thermal welding with an apparatus selected from a heating blade, heating grid and a heating plate. Thermal welding can be conducted continuously, for example, using a heating blade; it is likewise possible to conduct a mirror welding method using a heating plate or a heating grid. It is likewise possible that thermal welding, i.e. supply of heat using electromagnetic radiation, is conducted in part or in full.

In the bonding of at least two foam segments, at least one bonding surface forms between the surfaces of the at least two foam segments. If two foam segments are bonded to one another by thermal welding, this bonding surface is also referred to among specialists as weld seam, weld skin or weld zone.

The bonding surface may have any desired thickness and generally has a thickness of at least 2 μm, preferably at least 5 μm, more preferably in the range from 20 to 2000 μm and most preferably in the range from 50 to 800 μm.

The foam segments typically comprise cells. The mean cell wall thickness of the foam segments can be determined by any methods known to those skilled in the art, for example by light or electron microscopy by statistical evaluation of the cell wall thicknesses.

Preferably in accordance with the invention, the bonding surface between at least two of the mutually bonded foam segments is greater than the sum total of the mean cell wall thicknesses of the two foam segments.

Preference is also given to a molding of the invention, in which the foam segments comprise cells, where
i) at least 50%, preferably at least 80% and more preferably at least 90% of the cells of at least two foam segments, preferably of all foam segments, are anisotropic, and/or
ii) the ratio of the largest dimension (a direction) to the smallest dimension (c direction) of at least 50%, preferably at least 80% and more preferably at least 90% of the cells of at least two foam segments, preferably of all foam segments, is ≧1.05, preferably in the range from 1.1 to 10, especially preferably in the range from 1.2 to 5, and/or
iii) at least 50%, preferably at least 80% and more preferably at least 90% of the cells of at least two foam segments, preferably of all foam segments, based on their largest dimension (a direction), are aligned at an angle γ of ≦45°, preferably of ≦30° and more preferably of ≦5° relative to the thickness direction (d) of the molding.

An anisotropic cell has different dimensions in different spatial directions. The largest dimension of the cell is referred to as “a” direction and the smallest dimension as “c” direction. The third dimension is referred to as “b” direction.

The dimensions of the cell can be determined, for example, by means of light micrographs or electron micrographs.

It is also preferable that the mean size of the smallest dimension (c direction) of at least 50%, preferably at least 80% and more preferably at least 90% of the cells of at least two foam segments, preferably of all foam segments, is in the range from 0.01 to 1 mm, preferably in the range from 0.02 to 0.5 mm and especially in the range from 0.02 to 0.3 mm.

The mean size of the largest dimension (a direction) of at least 50%, preferably at least 80% and more preferably at least 90% of the cells of at least two foam segments, preferably of all foam segments, is typically not more than 20 mm, preferably between 0.01 to 5 mm, especially in the range from 0.03 to 1 mm and more preferably between 0.03 and 0.5 mm.

It is further preferable that at least 50%, preferably at least 80% and more preferably at least 90% of the cells of at least two foam segments, preferably of all foam segments, are orthotropic or transversely isotropic.

An orthotropic cell is understood to mean a special case of the anisotropic cell. Orthotropic means that the cells have three planes of symmetry. In the case that the planes of symmetry are oriented orthogonally to one another, based on an orthogonal system of coordinates, the dimensions of the cell are different in all three spatial directions, i.e. in a direction, in b direction and in c direction.

Transversely isotropic means that the cells have three planes of symmetry. However, the cells are invariant with respect to rotation about an axis which is the axis of intersection of two of the planes of symmetry. In the case that the planes of symmetry are oriented orthogonally to one another, only the dimension of the cell in one spatial direction is different than the dimension of the cell in the two other directions. For example, the dimension of the cell in a direction is different than that in b direction and that in c direction, and the dimensions in b direction and those in c direction are the same.

It is also preferable that at least two foam segments, preferably all foam segments, have a closed cell content of at least 80%, preferably at least 95%, more preferably at least 98%. The closed cell content of the foam segments is determined according to DIN ISO 4590 (as per German version August 2003). The closed cell content describes the proportion by volume of closed cells in the total volume.

It is further preferable that the fiber (F) is at an angle ε of ≦60°, preferably ≦50°, relative to the largest dimension (a direction) of at least 50%, preferably at least 80% and more preferably at least 90% of the cells of at least two foam segments, preferably of all foam segments, in the molding.

The anisotropic properties of the cells of at least two foam segments, preferably all foam segments, preferably result from the extrusion method which is preferred in one embodiment of the present invention. By virtue of the foamable polymer melt being extruded in step III) and the expanded foam thus obtained being calibrated in step IV), the extruded foam thus produced typically obtains anisotropic properties which result from the anisotropic cells.

If the properties of the foam segments are anisotropic, this means that the properties of the foam segments differ in different spatial directions. For example the compressive strength of the foam segments in thickness (z direction) may be different than in length (x direction) and/or in width (y direction).

Preference is further given to a molding of the invention in which
i) at least one of the mechanical properties, preferably all the mechanical properties, of at least two foam segments, preferably of all the foam segments, of the foam is/are anisotropic, preferably orthotropic or transversely isotropic, and/or
ii) at least one of the elastic moduli, preferably all the elastic moduli, of the extruded foam behave(s) in the manner of an anisotropic, preferably orthotropic or transversely isotropic, material, and/or
iii) the ratio of the compressive strength of at least two foam segments, preferably of all foam segments, of the foam in thickness (z direction) to the compressive strength of at least two foam segments, preferably of all foam segments, of the foam in length (x direction), and/or the ratio of the compressive strength of at least two foam segments, preferably of all foam segments, of the foam in thickness (z direction) to the compressive strength of at least two foam segments of the foam, preferably of all foam segments, in width (y direction), is ≧1.1, preferably ≧1.5, especially preferably between 2 and 10.

Mechanical properties are understood to mean all mechanical properties of foams that are known to those skilled in the art, for example strength, stiffness or elasticity, ductility and toughness.

The elastic moduli are known as such to those skilled in the art. The elastic moduli include, for example, the modulus of elasticity, the compression modulus, the torsion modulus and the shear modulus.

“Orthotropic” in relation to the mechanical properties or the elastic moduli means that the material has three planes of symmetry. In the case that the planes of symmetry are oriented orthogonally to one another, an orthogonal system of coordinates is applicable. The mechanical properties or the elastic moduli of the foam segments thus differ in all three spatial directions, x direction, y direction and z direction.

“Transversely isotropic” in relation to the mechanical properties or the elastic moduli means that the material has three planes of symmetry and that the moduli are invariant with respect to rotation about an axis which is the axis of intersection of two of the planes of symmetry. In the case that the planes of symmetry are oriented orthogonally to one another, the mechanical properties or the elastic moduli of the foam segments are different in one spatial direction than those in the two other spatial directions, but are the same in the two other spatial directions. For example, the mechanical properties or the elastic moduli in z direction differ from those in x direction and in y direction; those in x direction and in y direction are the same.

It will be clear to the person skilled in the art that, depending on the way in which the foam segments are bonded to one another, the foam and hence also the molding of the invention may be anisotropic or isotropic. Preferably, both the mutually bonded foam segments and the foam are anisotropic.

The compressive strength of the foam segments of the foam is determined according to DIN EN ISO 844 (October 2009 version).

The compressive strength of the foam segments in thickness (z direction) is typically in the range from 0.05 to 5 MPa, preferably in the range from 0.1 to 2 MPa, more preferably in the range from 0.1 to 1 MPa.

The compressive strength of the foam segments in length (x direction) and/or in width (y direction) is typically in the range from 0.05 to 5 MPa, preferably in the range from 0.1 to 2 MPa, more preferably in the range from 0.1 to 1 MPa.

The fiber (F) present in the molding is a single fiber or a fiber bundle, preferably a fiber bundle. Suitable fibers (F) are all materials known to those skilled in the art that can form fibers. For example, the fiber (F) is an organic, inorganic, metallic or ceramic fiber or a combination thereof, preferably a polymeric fiber, basalt fiber, glass fiber, carbon fiber or natural fiber, especially preferably a polyaramid fiber, glass fiber, basalt fiber or carbon fiber; a polymeric fiber is preferably a fiber of polyester, polyamide, polyaramid, polyethylene, polyurethane, polyvinyl chloride, polyimide and/or polyamide imide; a natural fiber is preferably a fiber of sisal, hemp, flax, bamboo, coconut and/or jute.

In one embodiment, fiber bundles are used. The fiber bundles are composed of several single fibers (filaments). The number of single fibers per bundle is at least 10, preferably 100 to 100 000 and more preferably 300 to 10 000 in the case of glass fibers and 1000 to 50 000 in the case of carbon fibers, and especially preferably 500 to 5000 in the case of glass fibers and 2000 to 20 000 in the case of carbon fibers.

According to the invention, the at least one fiber (F) is present with a fiber region (FB2) within the molding and is surrounded by the foam, while a fiber region (FB1) of the fiber (F) projects from a first side of the molding and a fiber region (FB3) of the fiber (F) projects from a second side of the molding.

The fiber region (FB1), the fiber region (FB2) and the fiber region (FB3) may each account for any desired proportion of the total length of the fiber (F). In one embodiment, the fiber region (FB1) and the fiber region (FB3) each independently account for 1% to 45%, preferably 2% to 40% and more preferably 5% to 30%, and the fiber region (FB2) for 10% to 98%, preferably 20% to 96% and more preferably 40% to 90%, of the total length of the fiber (F).

In a further preferred embodiment, the first side of the molding from which the fiber region (FB1) of the fibers (F) projects is opposite the second side of the molding from which the fiber region (FB3) of the fibers (F) projects.

The fiber (F) has preferably been introduced into the molding at an angle α relative to thickness direction (d) of the molding or to the orthogonal (of the surface) of the first side of the molding. The angle α may assume any values from 0° to 90°. For example, the fiber (F) has been introduced into the foam at an angle α of 0° to 60°, preferably of 0° to 50°, more preferably of 0° to 15° or of 10° to 70°, especially of 30° to 60°, more preferably of 30° to 50°, even more preferably of 30° to 45° and especially of 45° relative to the thickness direction (d) of the molding.

In a further embodiment, at least two fibers (F) are introduced at two different angles α, α₁ and α₂, where the angle α₁ is preferably in the range from 0° to 15° and the second angle α₂ is preferably in the range from 30° bis 50°; especially preferably, α₁ is in the range from 0° to 5° and α₂ in the range from 40° to 50°. Preferably, all fibers (F) in the molding of the invention have the same angle α or at least approximately the same angle (difference of not more than +/−5°, preferably +/−2°, more preferably +/−1°).

Preferably, a molding of the invention comprises a multitude of fibers (F), preferably as fiber bundles, and/or comprises more than 10 fibers (F) or fiber bundles per m², preferably more than 1000 per m², more preferably 4000 to 40 000 per m².

All fibers (F) may be present parallel to one another in the molding. It is likewise possible and preferable in accordance with the invention that two or more fibers (F) are present at an angle β to one another in the molding. The angle β is understood in the context of the present invention to mean the angle between the orthogonal projection of a first fiber (F1) onto the surface of the first side of the molding and the orthogonal projection of a second fiber (F2) onto the surface of the molding, both fibers having been introduced into the molding.

The angle β is preferably in the range of β=360°/n, where n is an integer. Preferably, n is in the range from 2 to 6, more preferably in the range from 2 to 4. For example, the angle β is 90°, 120° or 180°. In a further embodiment, the angle β is in the range from 80° to 100°, in the range from 110° to 130° or in the range from 170° to 190°. In a further embodiment, more than two fibers (F) have been introduced at an angle β to one another, for example three or four fibers (F). These three or four fibers (F) may each have two different angles β, β₁ and β₂, to the two adjacent fibers. Preferably, all the fibers (F) have the same angles β=β₁=β₂ to the two adjacent fibers (F). For example, the angle β is 90°, in which case the angle β₁ between the first fiber (F1) and the second fiber (F2) is 90°, the angle β₂ between the second fiber (F2) and third fiber (F3) is 90°, the angle β₃ between the third fiber and fourth fiber (F4) is 90°, and the angle β₄ between the fourth fiber (F4) and the first fiber (F1) is likewise 90°. The angles β between the first fiber (F1) (reference) and the second fiber (F2), third fiber (F3) and fourth fiber (F4) are then, in the clockwise sense, 90°, 180° and 270°. Analogous considerations apply to the other possible angles.

The first fiber (F1) in that case has a first direction, and the second fiber (F2) arranged at an angle β to the first fiber (F1) has a second direction. Preferably, there is a similar number of fibers in the first direction and in the second direction. “Similar” in the present context is understood to mean that the difference between the number of fibers in each direction relative to the other direction is <30%, more preferably <10% and especially preferably <2%.

The fibers or fiber bundles may be introduced in irregular or regular patterns. Preference is given to the introduction of fibers or fiber bundles in regular patterns. “Regular patterns” in the context of the present invention is understood to mean that all fibers are aligned parallel to one another and that at least one fiber or fiber bundle has the same distance (a) from all directly adjacent fibers or fiber bundles. Especially preferably, all fibers or fiber bundles have the same distance from all directly adjacent fibers or fiber bundles.

In a further preferred embodiment, the fibers or fiber bundles are introduced such that they, based on an orthogonal system of coordinates, where the thickness direction (d) corresponds to z direction, each have the same distance from one another (aₓ) in the x direction and the same distance (a_{y}) in the y direction. Especially preferably, they have the same distance (a) in x direction and in y direction, where a=aₓ=a_{y}.

If two or more fibers (F) are at an angle β to one another, the first fibers (F1) that are parallel to one another preferably have a regular pattern with a first distance (a₁), and the second fibers (F2) that are parallel to one another and are at an angle β to the first fibers (F1) preferably have a regular pattern with a second distance (a₂). In a preferred embodiment, the first fibers (F1) and the second fibers (F2) each have a regular pattern with a distance (a). In that case, a=a₁=a₂.

If fibers or fiber bundles are introduced into the foam at an angle β to one another, it is preferable that the fibers or fiber bundles follow a regular pattern in each direction.

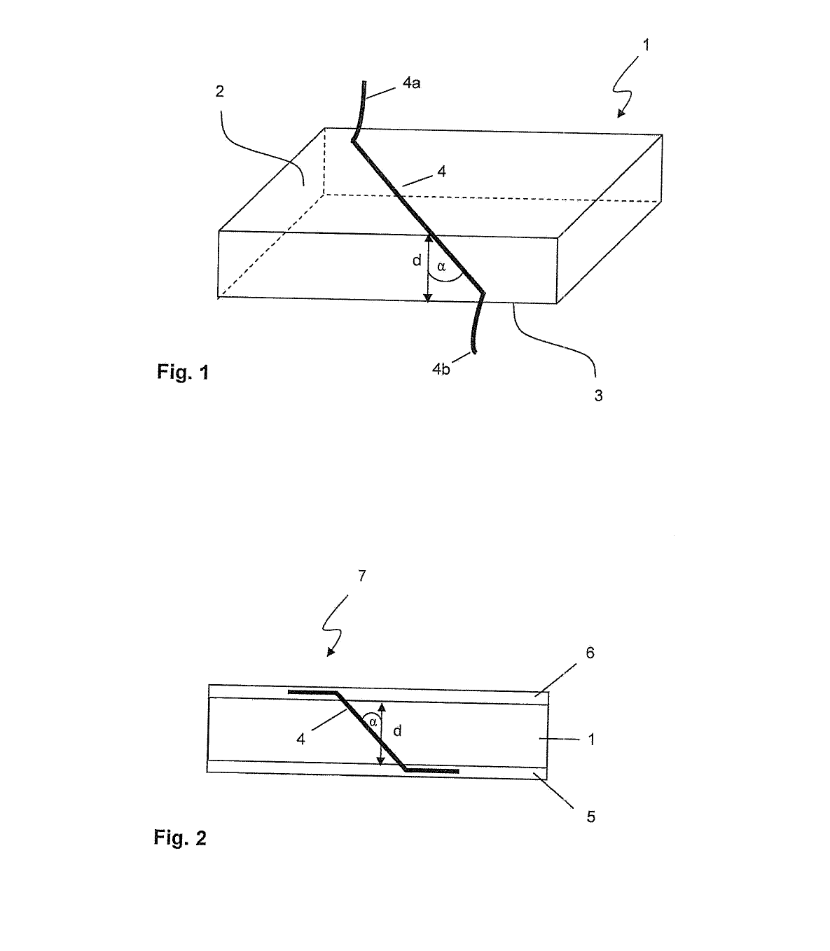

FIG. 1 shows a schematic diagram of a preferred embodiment of the molding of the invention made from foam (1) in a perspective view. (2) represents (the surface of) a first side of the molding, while (3) represents a second side of the corresponding molding. As further apparent from FIG. 1, the first side (2) of the molding is opposite the second side (3) of this molding. The fiber (F) is represented by (4). One end of this fiber (4a) and hence the fiber region (FB1) projects from the first side (2) of the molding, while the other end (4b) of the fiber, which constitutes the fiber region (FB3), projects from the second side (3) of the molding. The middle fiber region (FB2) is within the molding and is thus surrounded by the foam.

In FIG. 1, the fiber (4) which is, for example, a single fiber or a fiber bundle, preferably a fiber bundle, is at an angle α relative to thickness direction (d) of the molding or to the orthogonal (of the surface) of the first side (2) of the molding. The angle α may assume any values from 0° to 90°, and is normally 0° to 60°, preferably 0° to 50°, more preferably 0° to 15° or 10° to 70°, preferably 30° to 60°, especially 30° to 50°, even more preferably 30° to 45°, especially 45°. For the sake of clarity, FIG. 1 shows just a single fiber (F).

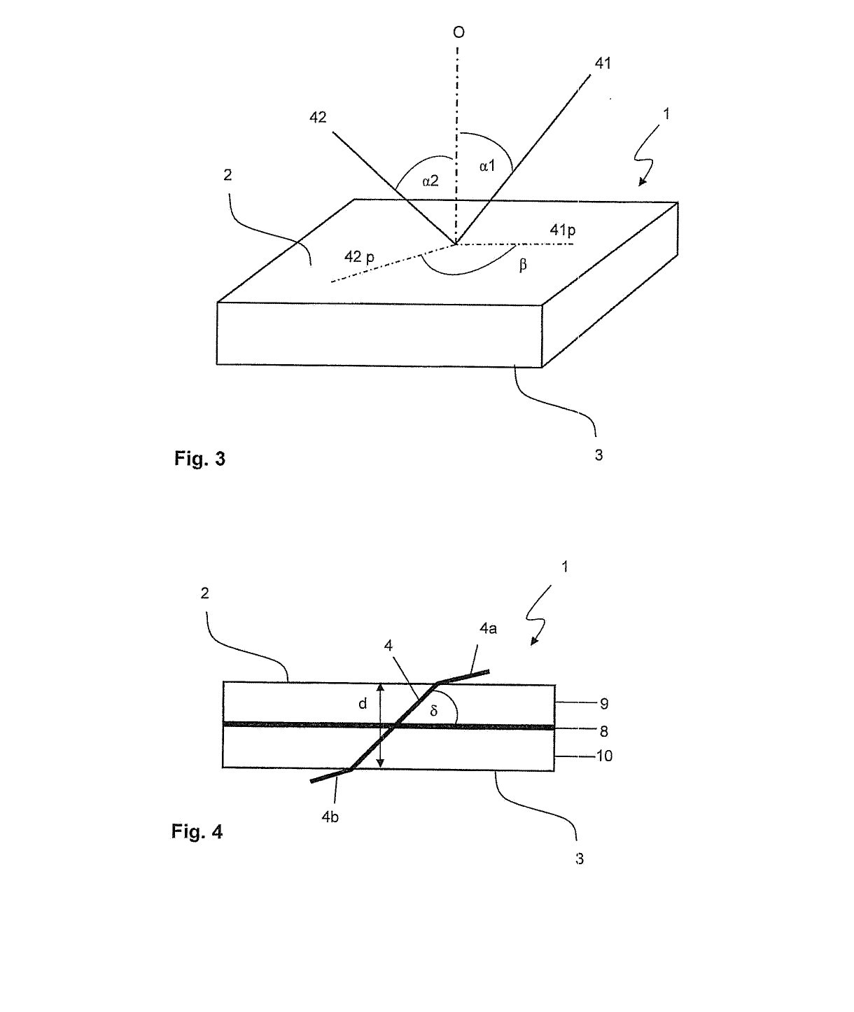

FIG. 3 shows, by way of example, a schematic diagram of some of the different angles. The molding made from foam (1) shown in FIG. 3 comprises a first fiber (41) and a second fiber (42). In FIG. 3, for better clarity, only the fiber region (FB1) that projects from the first side (2) of the molding is shown for the two fibers (41) and (42). The first fiber (41) forms a first angle α (α1) relative to the orthogonal (O) of the surface of the first side (2) of the molding. The second fiber (42) forms a second angle α (α2) relative to the orthogonal (O) of the surface of the first side (2). The orthogonal projection of the first fiber (41) onto the first side (2) of the molding (41p) forms the angle β with the orthogonal projection of the second fiber (42) onto the first side (2) of the molding (42p).

FIG. 4 shows, by way of example, a schematic diagram of the angle δ between the fiber (4) and the bonding surface between two mutually bonded foam segments (9, 10). The molding made from foam (1) shown in FIG. 4 comprises a fiber (4), a first foam segment (9), a second foam segment (10) and a bonding surface (8). For the sake of clarity, FIG. 4 shows only one fiber (4), only two foam segments (9, 10) and only one bonding surface (8). It will be apparent that the molding may comprise more than one bonding surface (8), more than two foam segments (9, 10) and more than one fiber (4). The fiber (4) has been introduced into the foam at an angle δ of ≧20°, preferably of ≧35°, especially preferably between 40° and 90°, relative to the bonding surface (8).

The present invention also provides a panel comprising at least one molding of the invention and at least one layer (S1). A “panel” may in some cases also be referred to among specialists as “sandwich”, “sandwich material”, “laminate” and/or “composite article”.

In a preferred embodiment of the panel, the panel has two layers (S1), and the two layers (S1) are each mounted on a side of the molding opposite the respective other side in the molding.

In one embodiment of the panel of the invention, the layer (S1) comprises at least one resin, the resin preferably being a reactive thermoset or thermoplastic resin, the resin more preferably being based on epoxides, acrylates, polyurethanes, polyamides, polyesters, unsaturated polyesters, vinyl esters or mixtures thereof, and the resin especially being an amine-curing epoxy resin, a latently curing epoxy resin, an anhydride-curing epoxy resin or a polyurethane formed from isocyanates and polyols. Resin systems of this kind are known to those skilled in the art, for example from Penczek et al. (Advances in Polymer Science, 184, p. 1-95, 2005), Pham et al. (Ullmann's Encyclopedia of Industrial Chemistry, vol. 13, 2012), Fahnler (Polyamide, Kunststoff Handbuch 3/4, 1998) and Younes (WO12134878 A2).

Preference is also given in accordance with the invention to a panel in which
i) the fiber region (FB1) of the fibers (F) is in partial or complete contact, preferably complete contact, with the first layer (S1), and/or
ii) the fiber region (FB3) of the fibers (F) is in partial or complete contact, preferably complete contact, with the second layer (S1), and/or
iii) the panel has at least one layer (S2) between at least one side of the molding and at least one layer (S1), the layer (S2) preferably being composed of two-dimensional fiber materials or polymeric films, more preferably of glass fibers or carbon fibers in the form of webs, scrims or weaves.

In a further inventive embodiment of the panel, the at least one layer (S1) additionally comprises at least one fibrous material, wherein
i) the fibrous material comprises fibers in the form of one or more laminas of chopped fibers, webs, scrims, knits and/or weaves, preferably in the form of scrims or weaves, more preferably in the form of scrims or weaves having a basis weight per scrim or weave of 150 to 2500 g/m², and/or
ii) the fibrous material comprises fibers of organic, inorganic, metallic or ceramic fibers, preferably polymeric fibers, basalt fibers, glass fibers, carbon fibers or natural fibers, more preferably glass fibers or carbon fibers.

The details described above are applicable to the natural fibers and the polymeric fibers.

A layer (S1) additionally comprising at least one fibrous material is also referred to as fiber-reinforced layer, especially as fiber-reinforced resin layer if the layer (S1) comprises a resin.

FIG. 2 shows a further preferred embodiment of the present invention. A two-dimensional side view of a panel (7) of the invention is shown, comprising a molding (1) of the invention, as detailed above, for example, within the context of the embodiment of FIG. 1. Unless stated otherwise, the reference numerals have the same meaning in the case of other abbreviations in FIGS. 1 and 2.

In the embodiment according to FIG. 2, the panel of the invention comprises two layers (S1) represented by (5) and (6). The two layers (5) and (6) are each thus on mutually opposite sides of the molding (1). The two layers (5) and (6) are preferably resin layers or fiber-reinforced resin layers. As further apparent from FIG. 2, the two ends of the fibers (4) are surrounded by the respective layers (5) and (6).

It is optionally possible for one or more further layers to be present between the molding (1) and the first layer (5) and/or between the molding (1) and the second layer (6). As described above for FIG. 1, FIG. 2 also shows, for the sake of simplicity, a single fiber (F) with (4). With regard to the number of fibers or fiber bundles, in practice, analogous statements apply to those detailed above for FIG. 1.

The present invention further provides a process for producing the molding of the invention, wherein at least one fiber (F) is partly introduced into the foam, as a result of which the fiber (F) is present with the fiber region (FB2) within the molding and is surrounded by the foam, while the fiber region (FB1) of the fiber (F) projects out of a first side of the molding and the fiber region (FB3) of the fiber (9 projects out of a second side of the molding.

Suitable methods of introducing the fiber (F) and/or a fiber bundle are in principle all those known to those skilled in the art. Suitable processes are described, for example, in WO 2006/125561 or in WO 2011/012587.

In one embodiment of the process of the invention, the at least one fiber (F) is partially introduced into the foam by sewing it in using a needle, preference being given to effecting the partial introduction by steps a) to f):
a) optionally applying at least one layer (S2) to at least one side of the foam,
b) producing one hole per fiber (F) in the foam and in any layer (S2), the hole extending from a first side to a second side of the foam and through any layer (S2),
c) providing at least one fiber (F) on the second side of the foam,
d) passing a needle from the first side of the foam through the hole to the second side of the foam, and passing the needle through any layer (82),
e) securing at least one fiber (F) on the needle on the second side of the foam, and
f) returning the needle along with the fiber (F) through the hole, such that the fiber (F) is present with the fiber region (FB2) within the molding and is surrounded by the foam, while the fiber region (FB1) of the fiber (F) projects from a first side of the molding or any layer (S2) and the fiber region (FB3) of the fiber (F) projects from a second side of the molding,
   more preferably with simultaneous performance of steps b) and d).

The details and preferences which follow for steps a) to f) of the process of the invention are correspondingly applicable to steps a) to f) of the process by which the fiber (F) has been introduced into the molding of the invention.

The application of at least one layer (S2) in step a) can be effected, for example, as described above during and/or directly after step IV).

In a particularly preferred embodiment, steps b) and d) are performed simultaneously. In this embodiment, the hole from the first side to the second side of the foam is produced by the passing of a needle from the first side of the foam to the second side of the foam.

In this embodiment, the introduction of the at least one fiber (F) may comprise, for example, the following steps:
a) optionally applying a layer (S2) to at least one side of the foam,
b) providing at least one fiber (F) on the second side of the foam,
c) producing one hole per fiber (F) in the foam and in any layer (S2), the hole extending from the first side to a second side of the foam and through any layer (S2), and the hole being produced by the passing of a needle through the foam and through any layer (S2),
d) securing at least one fiber (F) on the needle on the second side of the foam,
e) returning the needle along with the fiber (F) through the hole, such that the fiber
(F) is present with the fiber region (FB2) within the molding and is surrounded by the foam, while the fiber region (FB1) of the fiber (F) projects from a first side of the molding or from any layer (S2) and the fiber region (FB3) projects from a second side of the molding,
f) optionally cutting off the fiber (F) on the second side and
g) optionally cutting open the loop of the fiber (F) formed at the needle.

In a preferred embodiment, the needle used is a hook needle and at least one fiber (F) is hooked into the hook needle in step d).

In a further preferred embodiment, a plurality of fibers (F) are introduced simultaneously into the foam according to the steps described above.

The present invention further provides a process for producing the panel of the invention, in which the at least one layer (S1) in the form of a reactive viscous resin is applied to a molding of the invention and cured, preferably by liquid impregnation methods, more preferably by pressure- or vacuum-assisted impregnation methods, especially preferably by vacuum infusion or pressure-assisted injection methods, most preferably by vacuum infusion. Liquid impregnation methods are known as such to those skilled in the art and are described in detail, for example, in Wiley Encyclopedia of Composites (2nd Edition, Wiley, 2012), Parnas et al. (Liquid Composite Moulding, Hanser, 2000) and Williams et al. (Composites Part A, 27, p. 517-524, 1997).

Various auxiliary materials can be used for production of the panel of the invention. Suitable auxiliary materials for production by vacuum infusion are, for example, vacuum film, preferably made from nylon, vacuum sealing tape, flow aids, preferably made from nylon, separation film, preferably made from polyolefin, tearoff fabric, preferably made from polyester, and a semipermeable film, preferably a membrane film, more preferably a PTFE membrane film, and absorption fleece, preferably made from polyester. The choice of suitable auxiliary materials is guided by the component to be manufactured, the process chosen and the materials used, specifically the resin system. In the case of use of resin systems based on epoxide and polyurethane, preference is given to using flow aids made from nylon, separation films made from polyolefin, tearoff fabric made from polyester, and semipermeable films as PTFE membrane films, and absorption fleeces made from polyester.

These auxiliary materials can be used in various ways in the processes for producing the panel of the invention. Panels are more preferably produced from the moldings by applying fiber-reinforced outer plies by means of vacuum infusion. In a typical construction, for production of the panel of the invention, fibrous materials and optionally further layers are applied to the upper and lower sides of the molding. Subsequently, tearoff fabric and separation films are positioned. In the infusion of the liquid resin system, it is possible to work with flow aids and/or membrane films. Particular preference is given to the following variants:
i) use of a flow aid on just one side of the construction, and/or
ii) use of a flow aid on both sides of the construction, and/or
iii) construction with a semipermeable membrane (VAP construction); the latter is preferably draped over the full area of the molding, on which flow aids, separation film and tearoff fabric are used on one or both sides, and the semipermeable membrane is sealed with respect to the mold surface by means of vacuum sealing tape, and the absorption fleece is inserted on the side of the semipermeable membrane remote from the molding, as a result of which the air is evacuated upward over the full area, and/or
iv) use of a vacuum pocket made from membrane film, which is preferably positioned at the opposite gate side of the molding, by means of which the air is evacuated from the opposite side to the gate.

The construction is subsequently equipped with gates for the resin system and gates for the evacuation. Finally, a vacuum film is applied over the entire construction and sealed with sealing tape, and the entire construction is evacuated. After the infusion of the resin system, the reaction of the resin system takes place with maintenance of the vacuum.

The present invention also provides for the use of the molding of the invention or of the panel of the invention for rotor blades, in wind turbines, in the transport sector, in the construction sector, in automobile construction, in shipbuilding, in rail vehicle construction, for container construction, for sanitary installations and/or in aerospace.

The present invention is elucidated hereinafter by examples.

### EXAMPLES

### Example I1, C2, I3, C4, C8 and C9

First of all, foam segments in slab form are produced with different compositions. The foam segments are produced as extruded foams comprising polyphenyl ether (PPE) and polystyrene (PS) in a tandem extrusion system. A melting extruder (ZSK 120) is supplied continuously with a polyphenylene ether masterbatch (PPE/PS masterbatch, Noryl C6850, Sabic) and polystyrene (PS 148H, BASF), in order to produce an overall blend comprising 25 parts PPE and 75 parts PS. In addition, additives such as talc (0.2 part) are metered in via the intake as a PS masterbatch (PS 148H, BASF). Blowing agents (carbon dioxide, ethanol and isobutane) are injected into the injection port under pressure with various compositions. The total throughput including the blowing agents and additives is 750 kg/h. The foamable polymer melt is cooled down in a downstream cooling extruder (ZE 400) and extruded through a slot die. The expanded foam is taken off by a heated calibrator, the surfaces of which have been coated with Teflon, via a conveyor belt and formed to slabs. Typical slab dimensions prior to mechanical processing are width about 800 mm and thickness 60 mm. The mean density of the extruded foam is 50 kg/m³.

In example I1, bonding surfaces are produced by welding two foam slabs. In this case, the surface is first removed by means of a mill and leveled off. These foam slabs are subsequently heated contactlessly with a heating element welding machine and joined. The mean welding temperature is 350° C., the heating time is 2.5-4.0 s, and the distance between the heating element and foam slab is 0.7 mm. The resulting loss of thickness in welding is between 3-5 mm. The foam thus obtained is subsequently planed to thickness 20 mm.

A comparison used is an unwelded slab (comparative example C2), which is planed to thickness 20 mm.

A further comparison used is a slab according to comparative example C2 into which fibers have additionally been introduced by a tufting method (comparative example C8).

Likewise used as a comparison was a welded slab according to example I1, with fibers having been introduced by a tufting method (comparative example C9).

In the tufting method, a tufting needle from Schmitz with needle system designation 0647LH0545D300WE240RBNSPGELF was used with the CANU 83:54S 2 NM 250. This is the smallest tufting needle from Schmitz which is not specially manufactured.

In a tufting method, the fiber bundle is passed directly with the tufting needle from the first side of the foam through the foam to the second side of the foam and then the tufting needle is pulled back to the first side. A loop of the fiber bundle is formed on the second side of the foam. Since, in the tufting method, the hole in the foam is produced during the passage of the tufting needle along with the fiber bundle, the frictional forces that act on the tufting needle and the fiber bundle are high; at the same time, the bending radius of the fiber bundle in the eye of the needle is very tight. This combination leads to severing and splicing of the fiber bundles, such that they do not always form a loop and, moreover, not all fibers of the fiber bundle are introduced into the foam.

In order to very substantially eliminate these disadvantages and assure comparability with the process of the invention for introduction of the fiber, the tufting method in comparative example C8 and C9 was conducted as follows:

First of all, the hole was made in advance with the above-described tufting needle, then the fiber bundle, as described above, was introduced into the foam together with the tufting needle.

The same fiber bundles (rovings) as in example I1 and 13 and in comparative example C2 and C4 were used.

Polyester foams are subjected to foam extrusion through a multihole die in an extrusion system; the individual strands are bonded directly in the process. The mixture of polymer (mixture of 80 parts PET (bottle grade, viscosity index 0.74, M&G, P76) and 20 parts material recycled in the process), nucleating agent (talc, 0.4 part, masterbatch in PET), chain extender (PMDA, 0.4 part, masterbatch in PET) and polyolefin elastomer (Proflex CR0165-02, 10 parts, masterbatch in PET) is melted and mixed in a co-rotating twin screw extruder (screw diameter 132 mm). After the melting, cyclopentane is added as blowing agent (cyclopentane, 4.5 parts). Directly after addition of the blowing agent, the homogeneous melt is cooled by means of the downstream housing and the static mixer. The temperature of the extruder housing is 300° C. to 220° C. Before it reaches the multihole die, the melt has to pass through a melt filter. The multihole die has 8 rows each having a multitude of individual holes. The total throughput is about 150 kg/h. The die pressure is kept at at least 50 bar. The foamable polymer melt is foamed by means of the multihole die and the individual strands are combined to a block by means of a calibrator unit. The extruded slabs are subsequently subjected to finishing by material removal to a constant outer geometry with a slab thickness of 35 mm and joined by thermal welding parallel to the extrusion direction. The mean density of the foam is 50 kg/m³.

In example I3, internal support sites are produced by joining the foam slabs by means of thermal welding parallel to the extrusion direction. Contact welding after heating of the foam slab by means of a Teflon-coated hotplate is the method chosen. The foam thus obtained is subsequently planed to thickness 20 mm.

A comparative example used is an unwelded foam slab (comparative example C4), which is planed to thickness 20 mm.

The mean cell wall thickness of the foam segments and the thickness of the bonding surfaces are determined by statistical evaluation of scanning electron micrographs. The mean wall thickness of the support sites is determined in an analogous manner. The typical dimensions are shown in table 1.

An important factor for the handling of the moldings is that the fibers remain fixed within the foam slab in the course of handling. A quantitative measure determined is the pullout resistance or the force required to pull out the fibers by a pullout test.

The fibers in the form of rovings (E glass, 400 tex) are at first manually introduced into the foam perpendicularly to the surface and perpendicularly to the bonding surface in example I1 and I3 and comparative example C2 and C4. For this purpose, the fiber roving is introduced by a combined sewing/hooking process. First of all, a hook needle (diameter of about 0.80 mm) is used to penetrate completely from the first side to the second side of the foam. On the second side, a roving is hooked into the hook of the hook needle and then pulled from the second side by the needle back to the first side of the foam. Finally, the roving is cut off on the second side and the roving loop formed is hung up on the needle.

After the roving has been introduced, in all examples and comparative examples, the roving loop is secured to the load cell by means of a small bolt and, after the load cell has been balanced to zero, the foam is moved at a speed of 50 mm/min. A 1 kN load cell with an effective resolution of 1 mN is used. The foam is fixed manually during the movement of the machine. For the assessment of the pullout force, the force maximum is evaluated (mean from three measurements). In the tests, the maximum force always occurs at the start of the test, since the initial bond friction is greater than the subsequent sliding friction.

The maximum pullout force in the case of integration of the fiber rovings into the support sites, by the process according to the invention, is distinctly higher than in the case of fixing into the straight foam (I1 and I3 versus C2 and C4).

By contrast, there is no apparent effect of the support sites on the pullout force of fiber rovings that have been introduced by means of a tufting method (comparative example C9). This is a pointer that support sites are severely damaged in the tufting method and/or the clamp force is reduced by the size of the hole.

TABLE 1

| | | | Ratio of the bonding | |
|---|---|---|---|---|
| | | | surface thickness to | |
| | | | sum total of the mean | Maximum |
| | | | cell wall thickness | pullout |
| Exam- | | Bonding | of the two mutually | force |
| ple | Foam segment | surface | bonded foam segments | (N) |
| I1 | Extruded foam | Weld | ~100 | 1.17 |
| | (PPE/PS) | seam | | |
| C2 | Extruded foam | — | — | 0.74 |
| | (PPE/PS) | | | |
| I3 | Extruded foam | Weld | ~500 | 0.62 |
| | (PET-based) | seam | | |
| C4 | Extruded foam | — | — | 0.46 |
| | (PET-based) | | | |
| C8 | Extruded foam | — | — | 0.47 |
| | (PPE/PS) | | | |
| C9 | Extruded foam | Weld | ~100 | 0.19 |
| | (PPE/PS) | seam | | |

### Example I5

Moldings comprising mutually bonded foam segments and enveloped fibers are produced from the above-described PPE/PS foams (example I1), In the case of the extruded foam, the joined foam slabs are used in their present form with a thickness of 20 mm. The bonding surface runs exactly through the middle of the joined slabs. The slab has dimensions of 800 mm×600 mm; the mean thickness of the two joined slab elements was originally 60 mm; after the material-removing reduction in thickness, foam segments for final bonding of thickness 10 mm are obtained.

The compressive strength of the two foam segments in thickness direction (d) is 0.8 MPa and hence about 3.9 times higher than in the longitudinal or transverse direction (according to DIN EN ISO 844). In addition, the largest dimension (a direction) of the cells that have been analyzed by microscope images is oriented in thickness direction (d). The fibers are introduced at an angle α relative to thickness direction (d) of 45° and hence likewise at an angle of 45° to the bonding surface. The fibers used are glass rovings (S2 glass, 406 tex, AGY). The glass fibers are introduced in a regular rectangular pattern with equal distances a=12 mm. This gives rise to an area density of 27 778 rovings/m², all of which are fixed by the bonding surface. On both sides, about 5.5 mm of the glass fibers are additionally left as excess at the outer ply, in order to improve the binding to the glass fiber mats that will be introduced later as outer plies. The fibers or fiber rovings are introduced in an automated manner by a combined needle/hook process. First of all, a hook needle (diameter of about 0.80 mm) is used to penetrate completely from the first side to the second side of the foam. On the second side, a roving is hooked into the hook of the hook needle and then pulled from the second side by the needle back to the first side of the foam. Finally, the roving is cut off on the second side and the roving loop formed is cut open at the needle.

The utilization of the support sites in the foam enables distinctly better fixing of the fibers and hence better handling of the moldings. In addition, it is possible to reduce pullout of fibers in material-removing processing of the moldings.

### Example I6

Moldings comprising bonded foam segments and enveloped fibers are produced from the above-described PET foams (example I3). In the case of the extruded foam, first of all, several foam slabs having a length of 1500 mm, a width of 700 mm and a thickness of 35 mm are bonded by thermal welding. The foam obtained having a total thickness of 700 mm is subsequently cut by a bandsaw perpendicularly to the bonding surfaces and to the longitudinal direction of the original, unjoined slab into slabs having width/length dimensions of 700 mm×700 mm and a thickness of 20 mm. The foam slab thus consists of about 22 joined foam segments oriented perpendicularly to the slab thickness. The compressive strength of the foam elements in thickness direction (d) of the joined slab is 0.6 MPa and hence about 4.1 times higher than in the longitudinal or transverse direction (according to DIN EN ISO 844).

In addition, the largest dimension (a direction) of the cells that are analyzed by microscope images is oriented in thickness direction (d). The largest dimension (a direction) has a length of about 0.5 mm; the smallest dimension (c direction) is about 0.2 mm. The fibers are introduced at an angle α relative to thickness direction (d) of 45° and hence likewise at an angle δ of 45° to the bonding surface. The fibers are introduced analogously to example I5. Of the 27 778 rovings/m², about 30% have been fixed by the bonding surface.

The utilization of the support sites in the foam enable distinctly better fixing of the fibers and hence better handling of the moldings. In addition, it is possible to reduce pullout of fibers in material-removing processing of the moldings.

### Example I7

Panels are produced from the moldings for example I5. Fiber-reinforced outer plies are produced by means of vacuum infusion. As well as the resin systems used, the foam slabs and glass rovings, the following auxiliary materials are used: nylon vacuum film, vacuum sealing tape, nylon flow aid, polyolefin separation film, polyester tearoff fabric and PTFE membrane film and polyester absorption fleece. Panels are produced from the moldings by applying fiber-reinforced outer plies by means of vacuum infusion. Two plies of Quadrax glass rovings (E glass SE1500, OCV; textile: Saertex, isotropic laminate [0°/−45°/90° 45°] with 1200 g/m² in each case) each are applied to the upper and lower sides of the (fiber-reinforced) foams. The tearoff fabric and the flow aids are mounted on either side of the glass rovings. The construction is subsequently equipped with gates for the resin system and gates for the evacuation. Finally, a vacuum film is applied over the entire construction and sealed with sealing tape, and the entire construction is evacuated. The construction is prepared with a glass surface on an electrically heatable stage.

The resin system used is an amine-curing epoxide (resin: BASF Baxxores 5400, curing agent: BASF Baxxodur 5440, mixing ratio and further processing according to data sheet). After the two components have been mixed, the resin is evacuated at down to 20 mbar for 10 minutes. At a resin temperature of 23+/−2° C., infusion is effected onto the preheated structure (stage temperature: 35° C.). By means of a subsequent temperature ramp of 0.3 K/min from 35° C. to 75° C. and isothermal curing at 75° C. for 6 h, it is possible to produce panels consisting of the moldings and glass fiber-reinforced outer plies. The panels can be manufactured without difficulty. Moreover, the support sites can prevent pullout of the fibers in the preparation for vacuum infusion. For later mechanical stress in use, moreover, better fiber alignment and hence better durability are assured.

1.-15. (canceled)

16. A molding made of foam, said foam comprising at least two mutually bonded foam segments, wherein at least one fiber (F) is present with a fiber region (FB2) within the molding and is surrounded by the foam, while a fiber region (FB1) of the fiber (F) projects from a first side of the molding and a fiber region (FB3) of the fiber (F) projects from a second side of the molding, where the fiber (F) has been partly introduced by a process comprising the following steps a) to f):
a) optionally applying at least one layer (S2) to at least one side of the foam,
b) producing one hole per fiber (F) in the foam and in any layer (S2), the hole extending from a first side to a second side of the foam and through any layer (S2),
c) providing at least one fiber (F) on the second side of the foam,
d) passing a needle from the first side of the foam through the hole to the second side of the foam, and passing the needle through any layer (S2),
e) securing at least one fiber (F) on the needle on the second side of the foam, and
f) returning the needle along with the fiber (F) through the hole, such that the fiber (F) is present with the fiber region (FB2) within the molding and is surrounded by the foam, while the fiber region (FB1) of the fiber (F) projects from a first side of the molding or from any layer (S2) and the fiber region (FB3) of the fiber (F) projects from a second side of the molding.

17. The molding according to claim 16, wherein
i) at least two of the mutually bonded foam segments have been bonded to one another by adhesive bonding or welding, or
ii) the individual foam segments have a length (x direction) of at least 2 mm, a width (y direction) of at least 2 mm and a thickness (z direction) of at least 2 mm, or
iii) the individual foam segments have a slab shape, or
iv) the individual foam segments have a ratio of length (x direction) to thickness (z direction) of at least 5, or
v) the individual foam segments have a ratio of width (y direction) to thickness (z direction) of at least 3, or
vi) at least one fiber (F) passes through at least one bonding surface between two mutually bonded foam segments of the foam, or
vii) the at least one fiber (F) passes partly or completely through at least one bonding surface between two mutually bonded foam segments at an angle δ of ≧20°, or
viii) at least one bonding surface between at least two of the mutually bonded foam segments has/have a thickness of at least 2 μm, or
ix) the thickness of at least one bonding surface between at least two of the mutually bonded foam segments is greater than the sum total of the mean cell wall thicknesses of the mutually bonded foam segments.

18. The molding according to claim 16, wherein the foam segments of the foam are made from a molded foam, an extruded foam, a reactive foam or a masterbatch foam, that has been produced in a process comprising the following steps:
I) providing a polymer melt in an extruder,
II) introducing at least one blowing agent into the polymer melt provided in step I) to obtain a foamable polymer melt,
III) extruding the foamable polymer melt obtained in step II) from the extruder through at least one die aperture into an area at lower pressure, with expansion of the foamable polymer melt to obtain an expanded foam,
IV) calibrating the expanded foam from step III) by conducting the expanded foam through a shaping tool to obtain the extruded foam,
V) optional material-removing processing of the extruded foam obtained in step IV),
where
i) the polymer melt provided in step I) optionally comprises at least one additive, or
ii) at least one additive is optionally added during step II) to the polymer melt or between step II) and step III) to the foamable polymer melt, or
iii) at least one additive is optionally applied during step III) to the expanded foam or during step IV) to the expanded foam, or
iv) at least one layer (S2) is optionally applied to the extruded foam during or directly after step IV).

19. The molding according to claim 16, wherein the foam segments comprise cells, where
i) at least 50% of the cells of at least two foam segments, or
ii) the ratio of the largest dimension (a direction) to the smallest dimension (c direction) of at least 50% of the cells of at least two foam segments is ≧1.05, or
iii) at least 50% of the cells of at least two foam segments, based on their largest dimension (a direction), are aligned at an angle γ of ≦45° relative to the thickness direction (d) of the molding.

20. The molding according to claim 16, wherein the foam segments of the foam are based on at least one polymer selected from polystyrene, polyester, polyphenylene oxide, a copolymer prepared from phenylene oxide, a copolymer prepared from styrene, polyaryl ether sulfone, polyphenylene sulfide, polyaryl ether ketone, polypropylene, polyethylene, polyamide, polyamide imide, polyether imide, polycarbonate, polyacrylate, polylactic acid, polyvinyl chloride, or a mixture thereof.

21. The molding according claim 16, wherein all foam segments of the foam are based on the same polymers.

22. The molding according to claim 16, wherein
i) the fiber (F) is a single fiber or a fiber bundle, or
ii) the fiber (F) is an organic, inorganic, metallic or ceramic fiber or a combination thereof, or
iii) the fiber (F) is used in the form of a fiber bundle having a number of single fibers per bundle of at least 10, in the case of glass fibers and 1000 to 50 000 in the case of carbon fibers, or
the fiber region (FB1) and the fiber region (FB3) each independently account for 1% to 45% and the fiber region (FB2) for 10% to 98% of the total length of a fiber (F), or
v) the fiber (F) has been introduced into the foam at an angle α of 0° to 60°, or of 10° to 70° relative to the thickness direction (d) of the molding, or
vi) in the molding, the first side of the molding from which the fiber region (FB1) of the fibers (F) projects is opposite the second side of the molding from which the fiber region (FB3) of the fibers (F) projects, or
vii) the molding comprises a multitude of fibers (F), or comprises more than 10 fibers (F) or fiber bundles per m².

23. A panel comprising at least one molding according to claim 16 and at least one layer (S1).

24. The panel according to claim 23, wherein the layer (S1) comprises at least one resin.

25. The panel according to claim 24, wherein the resin being based on epoxides, acrylates, polyurethanes, polyamides, polyesters, unsaturated polyesters, vinyl esters or mixtures thereof.

26. The panel according to claim 23, wherein the layer (S1) additionally comprises at least one fibrous material, where
i) the fibrous material comprises fibers in the form of one or more laminas of chopped fibers, webs, scrims, knits or weaves, or
ii) the fibrous material comprises organic, inorganic, metallic or ceramic fibers.

27. The panel according to claim 23, wherein the panel has two layers (S1) and the two layers (S1) are each mounted on a side of the molding opposite the respective other side in the molding.

28. The panel according to claim 23, wherein
i) the fiber region (FB1) of the fibers (F) is in partial or complete contact with the first layer (S1), or
ii) the fiber region (FB3) of the fibers (F) is in partial or complete contact with the second layer (S1), or
iii) the panel has at least one layer (S2) between at least one side of the molding and at least one layer (S1).

29. The panel according to claim 28, wherein the layer (S2) preferably being composed of two-dimensional fiber materials or polymeric films.

30. A process for producing a molding according to claim 16, which comprises partly introducing at least one fiber (F) into the foam by means of steps a) to f):
a) optionally applying at least one layer (S2) to at least one side of the foam,
b) producing one hole per fiber (F) in the foam and in any layer (S2), the hole extending from a first side to a second side of the foam and through any layer (S2),
c) providing at least one fiber (F) on the second side of the foam,
d) passing a needle from the first side of the foam through the hole to the second side of the foam, and passing the needle through any layer (S2),
e) securing at least one fiber (F) on the needle on the second side of the foam, and
f) returning the needle along with the fiber (F) through the hole, such that the fiber (F) is present with the fiber region (FB2) within the molding and is surrounded by the foam, while the fiber region (FB1) of the fiber (F) projects from a first side of the molding or from any layer (S2) and the fiber region (FB3) of the fiber (F) projects from a second side of the molding,
optionally with simultaneous performance of steps b) and d).

31. A process for producing a panel according to claim 23, which comprises producing, applying and curing the at least one layer (S1) in the form of a reactive viscous resin on a molding according to claim 16.

32. The use of a molding according to claim 16 for rotor blades in wind turbines, in the transport sector, in the construction sector, in automobile construction, in shipbuilding, in rail vehicle construction, for container construction, for sanitary installations or in aerospace.
